(19) United States
(12) Patent Application Publication
(10) Pub. No.: US 2016/0332262 A1
(43) Pub. Date: Nov. 17, 2016

(54) FLUX FOR SOLDERING AND SOLDER COMPOSITION

(71) Applicant: FUJI ELECTRIC CO., LTD., Kanagawa (JP)

(72) Inventors: Ikuo SHOHJI, Maebashi-shi, Gunma (JP); Tatsuya GANBE, Asaka-shi, Saitama (JP); Hirohiko WATANABE, Hachioji-shi, Tokyo (JP)

(73) Assignee: FUJI ELECTRIC CO., LTD., Kawasaki-shi, Kanagawa (JP)

(21) Appl. No.: 14/909,929

(22) PCT Filed: Jan. 28, 2015
(86) PCT No.: PCT/JP2015/052364

§ 371 Date: Feb. 3, 2016

(30) Foreign Application Priority Data
Feb. 3, 2014 (JP) 2014-018824

(51) Int. Cl. B23K 35/362; B23K 35/26; B23K 35/36

(52) U.S. Cl. CPC B23K 35/362; B23K 35/3613; B23K 35/3618; B23K 35/262

(57) ABSTRACT

Provided is flux composition for a solder, which thermally cures so as to cover and reinforce a solder ball during solder ball bonding.

Employed is a flux for soldering, containing an epoxy resin, an organocarboxylic acid containing at least 0.1-40 mass % of a dicarboxylic acid having molecular weight of 180 or less, and a thixotropy-imparting agent, the epoxy resin and the organocarboxylic acid being blended such that there is 0.8-2.0 eq of the carboxyl groups of the organocarboxylic acid per 1.0 eq of the epoxy groups of the epoxy resin, and the epoxy resin, the organocarboxylic acid, and the thixotropy-imparting agent being contained in a total amount of 70 mass % or more relative to the total amount of the flux.

### TECHNICAL FIELD

The present invention relates to a flux for use in soldering an electronic component package or an electronic mounting board, and to a solder composition containing the same.

### BACKGROUND ART

During soldering, a soldering flux is used for the purpose of eliminating a natural oxide film on bond surfaces, and improving the solder wetting. For example, there are soldering fluxes that contain rosin or a rosin-modified resin, to which an activator composed of an organic acid or a halide salt has been added. With a rosin based soldering flux, flux residue remaining on the printed circuit board after soldering can cause corrosion of soldered bonds, thus necessitating cleaning with a CFC substitute or organic solvent. Production methods that employ large quantities of CFC substitutes or organic solvents are undesirable from an environmental impact standpoint. Given this background, no-clean fluxes that contain epoxy resins have been developed.

A flux containing an epoxy resin has an additional advantage, mentioned below. In a structure in which, for example, electrodes are arranged on the bottom surface of a package, referred to as “surface mounting,” electronic components and a printed board are joined by extremely small solder balls on the order of several ten to several hundred pm in diameter. However, with bonds that rely on solder balls alone, the problem of weakness to thermal fatigue and to drop impact is encountered, so it is common to fill gaps between electronic components and a printed board with a composite material of a resin and silica, called an “underfill material,” to reinforce the soldered bond. When a flux containing an epoxy resin is employed, the epoxy resin included within the flux thermally sets, covering the soldered bond and serving to reinforce the soldered bond, thereby rendering underfill unnecessary, so that manufacturing costs can be reduced.

By way of background art, Patent Document 1 discloses a no-clean flux composition that includes an epoxy resin. Document 2 discloses a soldering method, in which a thermal curing resin composition is deposited on solder ball surfaces before soldering. Document 3 discloses a cream solder composition, prepared by kneading solder particles and a thermal curing resin that includes an epoxy resin. However, with conventional thermally cured epoxy resins, it is a known tradeoff that, as hardness increases, the material becomes brittle. Moreover, as electronic components become lighter, thinner, and smaller, the solder bonds are reduced in size as well, and the force per unit area that bears on the solder bond increases, thereby making continuing increases in solder bond strength necessary.

Consequently, the most crucial issue in terms of further miniaturizing solder ball bonding is how to cover the solder bond subsequent to soldering, and increase the impact toughness of solder bonds.

### PRIOR ART DOCUMENTS

### Patent Documents

[Patent Document 1] Japanese Laid-Open Patent Application No. 2002-239785

[Patent Document 2] Japanese Laid-Open Patent Application No. 2012-84845

[Patent Document 3] Japanese Laid-Open Patent Application No. 2013-216830

### DISCLOSURE OF THE INVENTION

### Problems to be Solved by the Invention

An object of the present invention is to provide a flux for soldering and a solder composition, in solder ball mounting, having the function of covering a solder bond and increasing the impact toughness of the solder bond without the use of an underfill material.

### Means to Solve the Problems

To achieve the aforementioned object, the flux for soldering employed in the present invention is characterized by containing an epoxy resin, an organocarboxylic acid containing at least 0.1-40 mass % of a dicarboxylic acid having molecular weight of 180 or less, and a thixotropy-imparting agent, the epoxy resin and the organocarboxylic acid being blended such that there is 0.8-2.0 eq of carboxyl groups of the organocarboxylic acid per 1.0 eq of the epoxy groups of the epoxy resin, and the epoxy resin, the organocarboxylic acid, and the thixotropy-imparting agent being contained in a total amount of 70 mass % or more relative to the total amount of the flux.

The flux for soldering of the present invention preferably contains an organic solvent selected from the group consisting of polyhydric alcohols, monoalcohols, and mixtures thereof, in an amount of 30 mass % or less with respect to the total amount of the flux.

The flux for soldering of the present invention preferably further contains one or more activators for removing oxides, selected from amines, halogenated amine salts, halogenated organic acid salts, halogen compounds, organic acids, and acid anhydrides.

The epoxy resin included in the flux for soldering of the present invention is preferably an epoxy resin selected from the group consisting of bisphenol A epoxy resins, bisphenol F epoxy resins, novolac epoxy resins, alicyclic epoxy resins, and mixtures thereof.

The bisphenol A epoxy resin included in the flux for soldering of the present invention is preferably a bisphenol A epoxy resin having an epoxy equivalent of 160 g/ep to 250 g/ep.

The dicarboxylic acid having molecular weight of 180 or less included in the flux for soldering of the present invention is preferably selected from the group consisting of oxalic acid, malonic acid, succinic acid, glutaric acid, adipic acid, pimelic acid, suberic acid, phthalic acid, isophthalic acid, terephthalic acid, maleic acid, fumaric acid, itaconic acid, diglycolic acid, thiodiglycolic acid, methylmalonic acid, ethylmalonic acid, butylmalonic acid, dimethylglutaric acid, L-glutamic acid, tartaric acid, furandicarboxylic acid, thiophenedicarboxylic acid, cyclobutanedicarboxylic acid, cyclopropanedicarboxylic acid, cyclohexanedicarboxylic acid, 2,3-pyridinedicarboxylic acid, and mixtures thereof.

The polyhydric alcohol included in the flux for soldering of the present invention is preferably selected from the group consisting of ethylene glycol, diethylene glycol, triethylene glycol, propylene glycol, octene glycol, polyethylene glycol, propanediol, glycerin, and mixtures thereof.

The monoalcohol included in the flux for soldering of the present invention is preferably selected from the group consisting of methyl alcohol, ethyl alcohol, propyl alcohol, butyl alcohol, isobutyl alcohol, amyl alcohol, isoamyl alcohol, octanol, allyl alcohol, cyclohexanol, and mixtures thereof.

The solder composition of the present invention is characterized by containing the aforementioned flux for soldering, and a lead-free solder having melting point of 190° C.-240° C.

### Advantageous Effects of the Invention

According to the flux for soldering and the solder composition of the present invention, in solder ball mounting, a solder bond can be covered and the impact toughness of the solder bond increased without the use of an underfill material.

### BRIEF DESCRIPTION OF THE DRAWINGS

FIG. 1 is a cross sectional structure of a joining strength evaluation sample in an embodiment of the present invention;

FIG. 2 is a cross sectional structure of a joining strength evaluation sample employed as a comparative example;

FIG. 3 shows results of measurement of shear strength (maximum load) of solder balls;

FIG. 4 shows results of measurement of impact toughness of solder balls; and

FIG. 5 shows hardness changes associated with aging heat treatment of a thermally set flux according to the present invention.

### BEST MODE FOR CARRYING OUT THE INVENTION

The flux for soldering of the present invention contains an epoxy resin and an organocarboxylic acid, the epoxy resin and the organocarboxylic acid being blended such that there is 0.8-2.0 eq of the carboxyl groups of the organocarboxylic acid per 1.0 eq of the epoxy groups of the epoxy resin, and the total epoxy resin and organocarboxylic acid content being 70 mass % or more with respect to the total amount of flux. The epoxy resin and the organocarboxylic acid undergo a polymerization reaction in association with a rise in temperature, giving rise to curing of the flux, and by employing the flux of the present invention, the exothermic peak temperature of the flux curing reaction arising from polymerization of the epoxy resin and the organocarboxylic acid is 180-250° C., preferably 180-230° C., or the reaction initiation temperature of the flux curing reaction arising from polymerization of the epoxy resin and the organocarboxylic acid is 180-230° C. Therefore, even when a lead-free solder having a high melting point (about 190-240° C.) is employed, it is possible to prevent the organocarboxylic acid, which acts as an activator prior to melting of the solder, from becoming mostly consumed by the flux curing reaction arising from the polymerization reaction with the epoxy resin, and to thereby maintain the active power of the carboxylic acid is maintained, obtain good solder wetting, and as a result, achieve good soldering. Provided that the exothermic peak temperature of the polymerization reaction of the epoxy resin and the organocarboxylic acid is 180-250° C., a flux for which the reaction initiation temperature of the flux curing reaction arising from polymerization of the epoxy resin and the organocarboxylic acid is less than 180° C. may be employed as the flux of the present invention; however, from the standpoint of storage stability, it is preferable for initiation of the polymerization reaction to occur at no lower than 130° C. As indicated below, the epoxy resin and/or organocarboxylic acid contained in the flux of the present invention may be employed in the form of mixtures of a plurality of epoxy resins and/or mixtures of a plurality of organocarboxylic acids, and when employed in mixture form in this manner, it will suffice for the mixture to have the aforementioned exothermic peak temperature or reaction initiation temperature of the flux curing reaction arising from polymerization with respect of each of individual epoxy resins and organocarboxylic acids in the mixture, or to employ an epoxy resin and/or organocarboxylic acid which have the aforementioned exothermic peak temperature or reaction initiation temperature of the flux curing reaction arising from polymerization as the principal component of the mixture.

The reason for blending the epoxy resin and the organocarboxylic acid in the flux for soldering of the present invention, such that there is 0.8-2.0 eq of carboxyl groups of the organocarboxylic acid per 1.0 eq of epoxy groups of the epoxy resin is that when there is less than 0.8 eq of carboxyl groups of the organocarboxylic acid, the active power of the carboxylic acid is low, and the solder wetting declines, whereas when there is more than 2 eq of carboxyl groups of the organocarboxylic acid, excess solid carboxylic acid impairs the fluidity of the flux, so that solder wetting becomes poor. From the standpoint of improving the solder wetting, storage stability, insulating properties of the cured flux, and the like, the epoxy resin and the organocarboxylic acid are preferably blended such that there are 0.8-1.1 eq of carboxyl groups of the organocarboxylic acid per 1.0 eq of epoxy groups of the epoxy resin, and more preferably such that there is 1.0 eq of carboxyl groups of the organocarboxylic acid per 1.0 eq of epoxy groups of the epoxy resin. The reason that the epoxy resin and the organocarboxylic acid are contained in an total amount of 70 mass % or more with respect to the total amount of flux is that, where the total is less than 70 mass %, the active power of the carboxylic acid declines, and the solder wetting becomes poor.

The epoxy resin contained as the principal agent in the flux of the present invention is a component that is liquid at room temperature, that functions as a solvent for the organocarboxylic acid during preparation of the flux, and that as mentioned above, polymerizes with the organocarboxylic acid to give a cured flux. Further, the epoxy resin has excellent insulating properties. Because the epoxy resin and the organocarboxylic acid are consumed by the flux curing reaction, the amount thereof remaining as flux residue is minimal, and the flux can be used as a no-clean flux. Further, cured epoxy resin that remains as flux residue and bonds firmly to epoxy resin or the like of the printed board or package will cover the soldering site, reinforcing the bond.

The epoxy resin contained in the flux of the present invention is preferably a bisphenol A epoxy resin, a bisphenol F epoxy resin, a novolac epoxy resin, an alicyclic epoxy resin, or a mixture thereof, and more preferably a bisphenol A epoxy resin, a bisphenol F epoxy resin, or an alicyclic diglycidyl ester epoxy resin. The bisphenol A epoxy resin is preferably a bisphenol A epoxy resin having an epoxy equivalent of about 160-250 g/eq.

The organocarboxylic acid contained in the flux of the present invention functions as an activator for eliminating metal oxides and like, and is also employed in the curing reaction with the epoxy resin. The organocarboxylic acid undergoes a polymerization reaction with the epoxy resin to a sufficient extent, forming a cured flux; subsequent to reflow, the cured flux has good insulating properties. Because the organocarboxylic acid is consumed by the curing reaction with the epoxy resin or by a reaction with a sealing resin, use as a no-clean flux is possible.

The flux of the present invention includes a dicarboxylic acid having two carboxyl groups per molecule. The dicarboxylic acid bonds to the epoxy resin through an addition polymerization reaction, and forms a thermally cured material around the solder ball. The molecular weight of the dicarboxylic acid is preferably no more than 180, as when the molecular weight exceeds 180, the polymerization reaction during reflow is hampered by steric hindrance of molecules, during the addition polymerization reaction with the epoxy resin. The dicarboxylic acid is preferably contained at a level of 10-60 mass % with respect to the total amount of organocarboxylic acid included in the flux of the present invention. When the dicarboxylic acid concentration is less than 10 mass %, the degree of polymerization of the epoxy resin will be lower, and the strength of thermally cured flux will decline. Conversely, amounts above 60 mass % are disadvantageous in that the continuity of soldering suffers, and void production or defective fillet formation occur. The dicarboxylic acid having molecular weight of no more than 180 may be selected, for example, from the group consisting of oxalic acid, malonic acid, succinic acid, glutaric acid, adipic acid, pimelic acid, suberic acid, phthalic acid, isophthalic acid, terephthalic acid, maleic acid, fumaric acid, itaconic acid, diglycolic acid, thiodiglycolic acid, methylmalonic acid, ethylmalonic acid, butylmalonic acid, dimethylglutaric acid, L-glutamic acid, tartaric acid, furandicarboxylic acid, thiophenedicarboxylic acid, cyclobutanedicarboxylic acid, cyclopropanedicarboxylic acid, cyclohexanedicarboxylic acid, 2,3-pyridinedicarboxylic acid, and mixtures thereof. Generally, employing a saturated aliphatic dicarboxylic acid imparts stretchability due to —C—C— bond rotation, and impact resistance is improved.

Further, from the standpoint of improving the solder wetting, storage stability, and insulating properties of the cured flux, as well as making various qualities such as the coatability and printability of the flux better, a dicarboxylic acid having molecular weight greater than 180, or an activator other than the organocarboxylic acid in question (an amine, a halogen based activator, an acid anhydride, or the like) can be used as well.

The flux for soldering of the present invention may further include an alcohol, at a level of no more than 30 mass % with respect to the entire amount of flux. When the alcohol content exceeds 30 mass % of the entire amount of flux, solvent remains in the flux, giving rise to void defects and insulation defects. From the standpoint of improving the insulating properties of the cured flux in particular, the alcohol is preferably contained at a level of no more than 20 mass % with respect to the entire amount of flux; more preferably the alcohol is contained at a level of 10-20 mass % with respect to the entire amount of flux.

As the alcohol contained in the flux for soldering of the present invention, a monoalcohol, polyhydric alcohol, or mixture thereof can be employed. As monoalcohols, there can be cited, for example, methyl alcohol, ethyl alcohol, propyl alcohol, butyl alcohol, isobutyl alcohol, amyl alcohol, isoamyl alcohol, octanol, allyl alcohol, cyclohexanol, and mixtures thereof. As polyhydric alcohols, there may be cited ethylene glycol, diethylene glycol, triethylene glycol, propylene glycol, octene glycol, polyethylene glycol, propanediol, glycerol, and mixtures thereof. Polyhydric alcohols are preferred, and mixtures of a polyhydric alcohol and a monoalcohol are more preferred. With a mixture of a polyhydric alcohol and a monoalcohol, the insulating properties of the cured flux subsequent to reflow are better. Preferred monoalcohol/polyhydric alcohol mixtures are mixtures of a monoalcohol selected from the group consisting of amyl alcohol, octanol, and mixtures thereof, and a polyhydric alcohol selected from the group consisting of ethylene glycol, diethylene glycol, triethylene glycol, propylene glycol, polyethylene glycol, glycerol, propanediol, and mixtures thereof.

The present invention further relates to a solder composition containing the aforementioned flux, and a lead-free solder compatible with the flux. As the lead-free solder, preferably, there can be used a lead-free solder having a melting point of approximately 190-240° C., and more preferably a lead-free solder having a melting point of 210-230° C. In a preferred embodiment, a lead-free, Sn-containing solder having a melting point of approximately 190-240° C. is employed. The Sn-containing, lead-free solder varieties include Sn solder, Sn-Ag based solder, Sn-Cu based solder, Sn—Zn based solder, Sn—Sb based solder (melting point: approximately 190-240° C.), and the like. Sn—Ag based solders are more preferred. The Sn-Ag based solders includes Sn—Ag, Sn—Ag—Cu, Sn—Ag—Bi, Sn—Ag—Cu—Bi, Sn—Ag—Cu—In, Sn—Ag—Cu—S, and Sn—Ag—Cu—Ni—Ge, and the like. Sn—Ag—Cu based solders are more preferred.

As to the combination of the aforementioned flux and lead-free solder contained in the solder composition of the present invention, a suitable combination that is satisfactory in terms of various soldering properties, such as the solder wetting properties and the like, can be selected as appropriate. In preferred practice, a flux having an exothermic peak temperature that during the curing reaction is at or below the solder melting point will be employed, while a flux having an exothermic peak temperature that is approximately 10° C. higher than the solder melting point can be used as well. The solder in the solder composition is preferably contained at a level of approximately 85-95 mass % with respect to the total composition amount.

Optionally, a chelating agent, a defoaming agent, a surfactant, an antioxidant or the like may be added to the aforementioned flux and solder composition. The content of these components in the flux, in relation to the total flux amount, is preferably no more than 5 mass % of the chelating agent, no more than 1 mass % of the defoaming agent, no more than 2 mass % of the surfactant, and no more than 3 mass % of the antioxidant.

The flux for soldering of the present invention can be used as a no-clean flux in a reflow soldering process for an electronic component, that employs a lead-free solder. For example, in a reflow soldering process for an electronic component, prior to melting of the lead-free solder, a flux curing reaction produced by polymerization of the epoxy resin and the organocarboxylic acid includes in the epoxy based flux of the present invention is first initiated, and the organocarboxylic acid, which functions as an activator, cleans the solder joining surfaces. The initiation temperature of the polymerization-induced curing reaction of the flux of the present invention is approximately 180-230° C., or where the reaction initiation temperature is no more than approximately 180° C., the exothermic peak temperature is approximately 180-250° C., and preferably approximately 180-230° C., thereby preventing the organocarboxylic acid from being mostly consumed by the curing reaction prior to melting of the lead-free solder (melting point approximately 190-240° C.) Consequently, the active power of the carboxylic acid is maintained, and the solder wetting is improved. Next, as the heating temperature rises, the lead-free solder melts and solders together the electronic component and a conductor pattern on the printed board. The flux curing reaction proceeds during this interval as well, the reaction is brought to completion at substantially the same time as completion of soldering or subsequent to soldering through heating (curing of the sealing resin or the like), and the soldering site is covered by the epoxy resin, reinforcing the bond.

### EXAMPLES

### (Joining Strength Evaluation Sample)

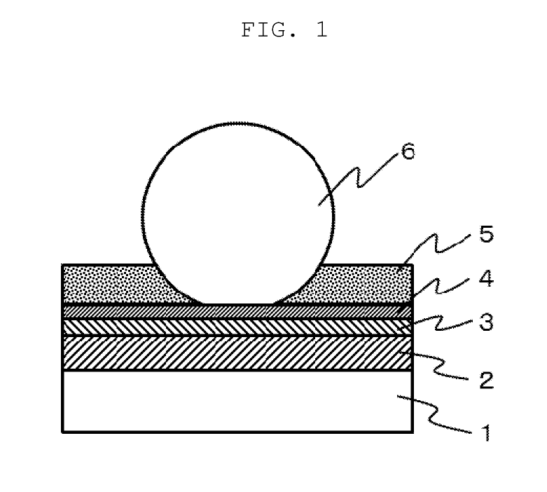

An evaluation sample having the cross sectional structure shown in FIG. 1 was prepared. An over-resist type FR-4 substrate 1 having a Cu layer 2 was employed. Onto the Cu layer 2 were layered, by electroless plating, an Ni—P plated layer 3 having thickness of 3 μm, and an Au plated layer 4 having thickness of 0.08 μm. Next, a resist 5 was applied onto the FR-4 substrate 1, and using a photolithography process, an opening with 200 μm in diameter was produced. A layered structure prepared in this fashion, comprising the Cu layer 2, the Ni-P plated layer 3, and the Au plated layer 4, and having an opening with 200 μm in diameter is called a Cu/Ni/Au electrode. Next, using a metal mask with a 100% opening area, flux was applied over the surface of the FR-4 substrate 1, an Sn-3 Ag-0.5 Cu (mass %) solder sphere with 300 μm in diameter was placed thereon, and reflow soldering was carried out under reflow conditions of a peak temperature of 243° C. and a hold time of 44 s at 220° C. or above, forming a solder ball 6. Finally, the sample underwent aging heat treatment at 120° C. (significant as a high-temperature accelerated test, in order to evaluate the reliability of an electronic device within a short time).

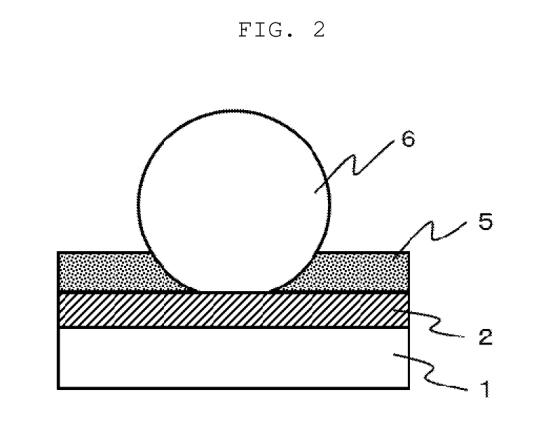

At the same time, in order to examine effects on the electrode structure, a Cu electrode sample lacking Ni—P/Au plated layers, shown in FIG. 2, was evaluated as well.

### (Joining Strength Test)

Using an impact resistant high-speed bondtester (model 4000HS made by DAGE), high-speed shear tests were carried out at room temperature. The tests involved pushing solder balls with a shear tool in the horizontal direction under conditions of a shear height of 50 μm and a shear rate of 1 m/s, and measuring the load values at the time. A load-displacement curve was derived, and designating the maximum value of load as the shear strength, the load-displacement curve was integrated to give a value as the energy absorbed by the bond, which was designated as the impact toughness.

### (Hardness Measurement of Thermally Cured Flux)

The hardness of thermally cured flux remaining and covering the solder ball was measured at room temperature, using a nanoindenter (model ENT1100A made by ELIONIX Inc.).

### Example

To 16.7 g of a higher alcohol (triethylene glycol) were added 15 g of a dicarboxylic acid of molecular weight of no more than 180 (cis-4-cyclohexane-1,2-dicarboxylic acid) and 13.5 g of another organic acid (dodecanedioic acid), heating to 130° C. to dissolve. Subsequently, 2 g of a thixotropy-imparting agent (12-hydroxystearamide) and 52.8 g of a bisphenol A epoxy resin having an epoxy equivalent of 192 g/ep were added, and stirred until homogeneous, to prepare an epoxy based flux according to the present invention. The epoxy resin and the carboxylic acid included in the flux were blended such that there was 1.05 eq of carboxyl groups per 1 eq of the epoxy, and the total epoxy resin, carboxylic acid, and thixotropy-imparting agent content was 83.3 mass % of the total amount of flux. The alcohol content was 16.7 mass % of the total amount of flux. Next, the epoxy based flux of the present invention was applied onto a Cu/Ni/Au electrode having the cross sectional structure shown in FIG. 1, an Sn-3 Ag-0.5 Cu (mass %) solder sphere with 300 μm in diameter was placed thereon, and reflow soldering was carried out under reflow conditions of a peak temperature of 243° C. and a hold time of 44 s at 220° C. or above, forming a solder ball. Finally, the sample underwent aging heat treatment at 120° C. Four levels of samples, specifically, samples not subjected to aging heat treatment, and samples subjected to aging heat treatment for one week, three weeks, and six weeks, were prepared. At the same time, the epoxy based flux of the present invention was applied to a Cu electrode having the cross sectional structure shown in FIG. 2, and comparative samples having undergone reflow soldering and aging heat treatment identical to the aforedescribed were prepared. Finally, using the epoxy based flux of the present invention, the joining strength of solder balls prepared by the aforedescribed method was evaluated with an impact resistant high-speed bondtester. At the same time, the hardness of thermally cured flux remaining and covering the solder ball was measured with a nanoindenter.

### Comparative Example

A commercially available rosin based flux (model 117 made by NIHON HANDA Co.) was applied onto a Cu/Ni/Au electrode having the cross sectional structure shown in FIG. 1, and then a solder ball was formed by the same procedure as in the Example. At the same time, the flux was applied to a Cu electrode having the cross sectional structure shown in FIG. 2, and then a solder ball was formed by the same procedure as in the Example.

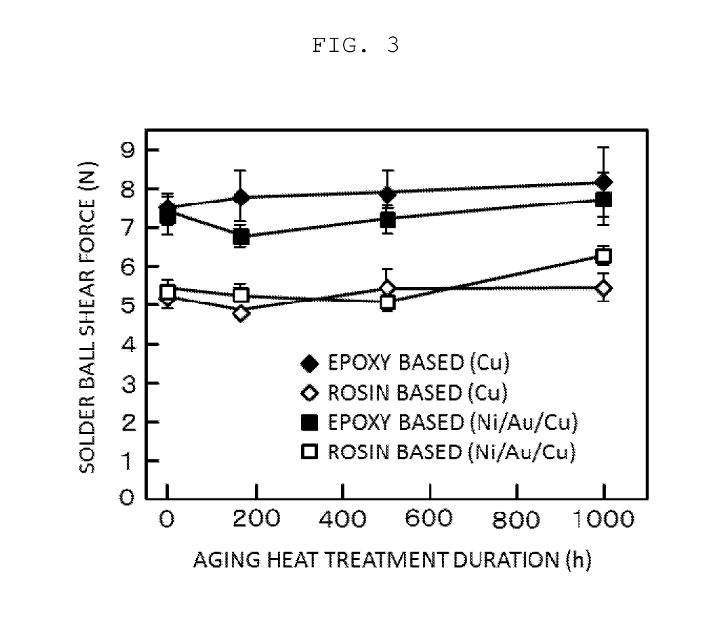

Changes in shear strength, plotted against the duration of aging heat treatment, obtained through joining strength tests of solder balls employing the epoxy based flux of the Example, and solder balls employing the rosin based flux of the Comparative Example, are shown in FIG. 3. Large changes in shear strength were not observed in any of the samples. Consequently, the solder balls employing the epoxy based flux had high shear strength approximately 150% of the solder balls employing the rosin based flux, both initially and after six weeks.

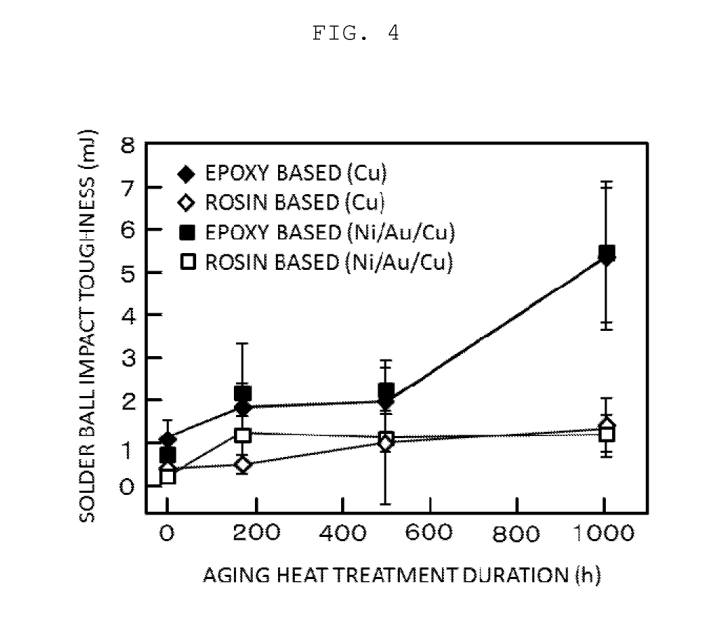

FIG. 4, on the other hand, shows impact toughness plotted against the duration of aging heat treatment. The impact toughness characteristic of solder balls employing epoxy based flux is greatly improved by heat treatment. Impact toughness approximately doubled during the initial one week; after subsequently reaching temporary saturation, impact toughness increased sharply starting after three weeks, rising to approximately 5-fold that of the initial value after six weeks. In the case of the solder balls employing rosin based flux, the increase in the impact toughness was gradual, and became substantially saturated after three weeks had passed, rising to approximately double the initial value after six weeks. Consequently, the impact toughness of the epoxy based flux solder balls, prior to aging heat treatment, was approximately double that of the rosin based flux solder balls, and after six weeks of aging heat treatment, rose to approximately 5-fold that of the rosin based flux solder balls, demonstrating exceptional impact toughness.

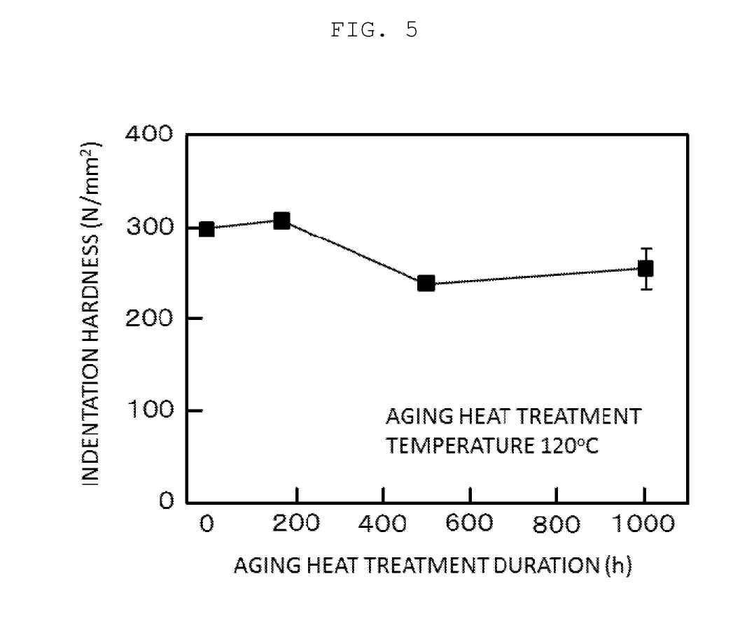

FIG. 5 shows the results of a nanoindenter inspection of change in hardness occurring with heat treatment, in thermally cured epoxy based flux remaining around a bond. As shown in FIG. 5, it is clear that the hardness of thermally cured epoxy based flux covering a bond declined with heat treatment. It is shown that the effect of lowered hardness with heat treatment, a rise in interfacial strength accompanying uniform growth of the interfacial reaction layer, and the decline in solder hardness acted synergetically to make it easier for the epoxy based flux to absorb the load of impact on a bond, and the impact toughness rose with heat treatment.

### EXPLANATION OF NUMERALS AND CHARACTERS

1: FR-4 substrate
2: Cu layer
3: Ni—P plating layer
4: Au plating layer
5: Resist
6: Solder ball

1. A flux for soldering, wherein epoxy resin and an organocarboxylic acid containing at least 10-60 mass % of a dicarboxylic acid having molecular weight of at most 180, are blended such that there is 0.8-2.0 eq of the carboxyl groups of the organocarboxylic acid per 1.0 eq of the epoxy groups of the epoxy resin, and the epoxy resin and the organocarboxylic acid are contained in a total amount of at least 70 mass % are relative to the total amount of the flux.

2. The flux for soldering according to claim 1, further comprising an organic solvent selected from a group consisting of polyhydric alcohols, monoalcohols, and mixtures thereof, in an amount of at most 30 mass % with respect to the total amount of flux.

3. The flux for soldering according to claim 1, further comprising at least one activator for removing oxides, selected from amines, halogenated amine salts, halogenated organic acid salts, halogen compounds, organic acids, and acid anhydrides.

4. The flux for soldering according to claim 1, wherein the epoxy resin is selected from a group consisting of bisphenol A epoxy resins, bisphenol F epoxy resins, novolac epoxy resins, alicyclic epoxy resins, and mixtures thereof.

5. The flux for soldering according to claim 4, wherein the bisphenol A epoxy resin is a bisphenol A epoxy resin having an epoxy equivalent of 160 g/eq to 250 g/eq.

6. The flux for soldering according to claim 1, wherein the dicarboxylic acid having molecular weight of at most 180 is selected from a group consisting of oxalic acid, malonic acid, succinic acid, glutaric acid, adipic acid, pimelic acid, suberic acid, phthalic acid, isophthalic acid, terephthalic acid, maleic acid, fumaric acid, itaconic acid, diglycolic acid, thiodiglycolic acid, methylmalonic acid, ethylmalonic acid, butylmalonic acid, dimethylglutaric acid, L-glutamic acid, tartaric acid, furandicarboxylic acid, thiophenedicarboxylic acid, cyclobutanedicarboxylic acid, cyclopropanedicarboxylic acid, cyclohexanedicarboxylic acid, 2,3-pyridinedicarboxylic acid, and mixtures thereof.

7. The flux for soldering according to claim 2, wherein the polyhydric alcohol is selected from a group consisting of ethylene glycol, diethylene glycol, triethylene glycol, propylene glycol, octene glycol, polyethylene glycol, propanediol, glycerin, and mixtures thereof.

8. The flux for soldering according to claim 2, wherein the monoalcohol is selected from a group consisting of methyl alcohol, ethyl alcohol, propyl alcohol, butyl alcohol, isobutyl alcohol, amyl alcohol, isoamyl alcohol, octanol, allyl alcohol, cyclohexanol, and mixtures thereof.

9. A solder composition comprising the flux for soldering according to claim 1, and a lead-free solder having a melting point of 190° C.-240° C.

10. A solder composition comprising the flux for soldering according to claim 2, and a lead-free solder having a melting point of 190° C.-240° C.

11. A solder composition comprising the flux for soldering according to claim 3, and a lead-free solder having a melting point of 190° C.-240° C.

12. A solder composition comprising the flux for soldering according to claim 4, and a lead-free solder having a melting point of 190° C.-240° C.

13. A solder composition comprising the flux for soldering according to claim 5, and a lead-free solder having a melting point of 190° C.-240° C.

14. A solder composition comprising the flux for soldering according to claim 6, and a lead-free solder having a melting point of 190° C.-240° C.

15. A solder composition comprising the flux for soldering according to claim 7, and a lead-free solder having a melting point of 190° C.-240° C.

16. A solder composition comprising the flux for soldering according to claim 8, and a lead-free solder having a melting point of 190° C.-240° C.
